(19) United States
(12) Patent Application Publication
(10) Pub. No.: US 2008/0005685 A1
(43) Pub. Date: Jan. 3, 2008

(54) INTERFACE MECHANISM FOR QUICKLY ACCESSING RECENTLY USED ARTIFACTS IN A COMPUTER DESKTOP ENVIRONMENT

(76) Inventors: Clemens Drews, San Jose, CA (US); James Lin, Cupertino, CA (US); Michael Muller, Medford, MA (US); Andrew L. Schirmer, Andover, MA (US); John C. Tang, Palo Alto, CA (US)

Correspondence Address: HOFFMAN WARNICK & DALESSANDRO LLC, 75 STATE STREET, 14TH FLOOR, ALBANY, NY, 12207, US

(21) Appl. No.: 11/427,965

(22) Filed: Jun. 30, 2006

(51) Int. Cl. G06F 9/00

(52) U.S. Cl. 715/764; 715/769; 715/765

(57) ABSTRACT

Interface mechanism for quickly accessing recently used artifacts in a computer desktop environment. The interface mechanism integrates across a multitude of tools available in a computer desktop environment to present a list of recently used computer artifacts that can be automatically sorted or filtered in useful ways. Examples of computer-based artifacts that the interface can present include objects that relate to people, events, URLs, email messages, attachments, shared objects or shared activities. Filtering and sorting operations enable the interface mechanism to provide a list of the computer artifacts in a manner that is useful to the user. Also, the interface mechanism permits to perform frequently desired operations beyond opening a file or application such as dragging and dropping items for copying and pasting into the user's current context.

### TECHNICAL FIELD

This disclosure generally relates to computer user interfaces, and more specifically to an interface mechanism that quickly accesses recently used artifacts in a computer desktop environment.

### BACKGROUND

Recent developments in computer user interfaces have recognized the practical convenience of tracking recent user interactions and saving work that a user may want to reuse soon thereafter. For example, modern operating systems have introduced a very useful feature of tracking recently used files and applications. In System 7.5, Apple Mac OS introduced a menu of recently used applications that was available from anywhere on the computer desktop through the Apple menu. Menus for recently used files and servers were added in subsequent versions of Mac OS. Apple, Mac OS, and Mac OS X, are trademarks of Apple Corporation in the United States, other countries, or both. Microsoft Windows 95 introduced a Documents submenu from the Start menu that lists recently accessed documents. Microsoft, Windows, Windows NT, and the Windows logo are trademarks of Microsoft Corporation in the United States, other countries, or both. In Windows XP, the menu is known as My Recent Documents.

This system permits the user to open a file, launch an application, or open a connection to the server from the menu. More recently, Apple has introduced Recent Places into certain file choosing dialogs that point to recently used file folders, which can be helpful when saving or opening files.

Microsoft Windows and Apple Mac OS X also offer facilities along one edge of the computer screen to access files that are still open (i.e., the taskbar and the dock, respectively). In the most recent version of Windows (Windows XP), those files are grouped by application (e.g., all Microsoft Word files are collapsed into one tab for Word that brings up a menu of each individual file). Lotus Notes also leaves tabs of open database entries for easy future access. Lotus Notes is a trademark of the International Business Machines Corporation in the United States, other countries or both.

Clicking on an entry in My Recent Documents or on the taskbar in Windows opens up the file or application. While Windows does offer some other common actions on the items in My Recent Documents (e.g., scan for virus, print), it does not offer universal copy and paste. Windows allows you to copy a shortcut from My Recent Documents (because it is actually composed of a list of shortcuts), but pasting a shortcut does not actually copy the file in the ways that a user would like. For example, pasting a shortcut into an email message as an attachment is not allowed, because shortcuts will not work beyond the user's local desktop. Furthermore, a user may want to perform other actions on these items, such as viewing the hierarchical context of a file, which are not enabled through Windows.

While being able to access files, applications, and servers from anywhere on the desktop is very useful, users may also need access to other kinds of computer artifacts or objects, like email addresses and other references to people (e.g., IM names, phone numbers), and URLs. Furthermore, users may want to perform other actions with those artifacts beyond simply opening them for viewing, such as copying and pasting or viewing the surrounding context of an item.

Therefore, there is a need to extend beyond the current capabilities of recently used files, applications and servers to include other frequently used computer artifacts, and allow the user to do more than just open the artifacts. It would be even more useful if access to such computer artifacts were available through a single, easily-accessible interface mechanism that offers frequently desired actions on those artifacts.

### SUMMARY

In one embodiment, there is a method for quickly accessing recently used artifacts in a computer desktop environment. In this embodiment, recent user interactions with tools available in the computer desktop environment are tracked. The recently used artifacts from the tracked user interactions are recorded, collected and indexed. A user interface that displays a list of the recently used artifacts according to the index is presented. A user is then permitted to perform one of a plurality of processing operations on the recently used artifacts. The plurality of processing operations comprise double clicking on one of the recently used artifacts to open or execute, dragging and dropping one of the recently used artifacts to a different location within the computer desktop environment, and single clicking on one of the recently used artifacts to ascertain further information.

In another embodiment, there is a computer-readable medium storing computer instructions for generating a user interface that allows a user of a computer system to quickly access recently used artifacts within a computer desktop environment. In this embodiment, the instructions comprise tracking recent user interactions with tools available in the computer desktop environment; recording recently used artifacts from the tracked user interactions; collecting the recorded recently used artifacts; providing an index of the collected recently used artifacts; presenting a user interface that displays a list of the recently used artifacts according to the index, wherein the presenting comprises filtering and sorting the artifacts in the index according to the current context in which the user recently interacted with the tools available in the computer desktop environment; and permitting a user to perform one of a plurality of processing operations on the recently used artifacts presented to the user, wherein the plurality of processing operations comprise double clicking on one of the recently used artifacts to open or execute, dragging and dropping one of the recently used artifacts to a different location within the computer desktop environment, and single clicking on one of the recently used artifacts to ascertain further information.

In a third embodiment, there is a system for quickly accessing recently used artifacts in a computer desktop environment. The system comprises a plurality of listeners configured to track recent user interactions with tools available in the computer desktop environment and record recently used artifacts from the tracked user interactions. A data store is configured to collect the recorded recently used artifacts from the plurality of listeners and organize and index them. A user interface is configured to display a list of the recently used artifacts according to the index in the data store. The user interface is further configured to filter and sort the artifacts in the index according to the current context in which the user recently interacted with the tools available in the computer desktop environment. The user interface is further configured to permit a user to perform one of a plurality of processing operations on the recently used artifacts presented to the user. The plurality of processing operations comprise double clicking on one of the recently used artifacts to open or execute, dragging and dropping one of the recently used artifacts to a different location within the computer desktop environment, and single clicking on one of the recently used artifacts to ascertain further information.

### BRIEF DESCRIPTION OF THE DRAWINGS

FIG. 1 shows a high-level component architecture diagram of an interface system for quickly accessing recently used artifacts in a computer desktop environment;

FIG. 2 is a flowchart describing some of the processing functions associated with quickly accessing recently used artifacts in the system shown in FIG. 1;

FIGS. 3a-3d are exemplary screenshots that could be presented to a user of the system shown in FIG. 1; and

FIG. 4 shows a schematic of an exemplary computing environment in which the system shown in FIG. 1 may operate.

### DETAILED DESCRIPTION

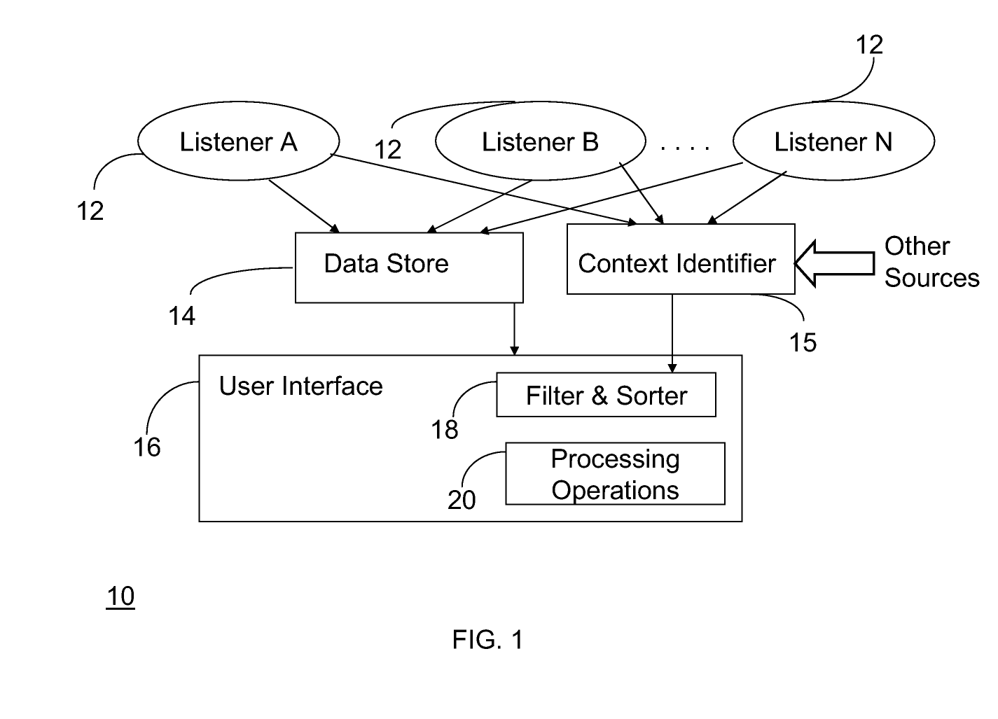

FIG. 1 shows an interface system 10 for quickly accessing recently used artifacts in a computer desktop environment. In this disclosure, artifacts or objects are generally any computer-based entity that a computer can recognize as distinct items and present in a list to a user. An illustrative, but non-limiting list of recently used artifacts that the interface system 10 can quickly access for re-use include items relating to people (e.g., email addresses, instant messaging screen names, phone numbers, directory entries, memberships, database entries, groups of people, ad-hoc groups), events (i.e., calendar appointments), URLs, email messages, attachments in email messages, files and folders and shared objects or activities. One of ordinary skill in the art will recognize that other recently used artifacts are suitable for use with the interface system 10 and therefore this disclosure should not be limited to any particular computer artifacts.

The interface system 10 as shown in FIG. 1 includes a plurality of listeners 12 configured to track recent user interactions with tools available in the computer desktop environment and record recently used artifacts from the tracked user interactions. The listeners 12 are generally software modules that connect through application programmer interfaces (APIs) to plug into the various tools that may be available in the desktop. An illustrative, but non-limiting list of possible tools that could be available on a computer desktop and that are suitable for tracking recent user interactions and recently used artifacts include email applications, instant messenger applications, operating systems, calendars, web browsers, and various other communication applications. The listeners 12 can track recent user interactions and record recently used artifacts with these tools by sensing any application operations where the user interacts with a computer object, or any other operations of interest. For example, in the Operating System, the listeners sense any files that are opened, saved, renamed, etc. In email, the listener detects any people corresponded with via email plus any email attachments received via email. For some of the above-mentioned tools, the plurality of listeners can obtain the recent user interactions and recently used artifacts by tapping into the information that some applications use for their own purposes. Some examples of tools maintaining their own information include web browsers (e.g., web history), email applications (e.g., auto completion of names that there have been communications with), operating systems (e.g., My Recent Documents in Windows).

FIG. 1 also shows a data store 14 that is configured to collect the recorded recently used artifacts from the plurality of listeners 12. After collecting the recorded recently used artifacts, the data store 14 organizes the items into an index. Preferably, the data store 14 provides an index of recently used artifacts in a manner that facilitates presentation in a user interface to a user. Although FIG. 1 discloses the use of a data store, one of ordinary skill in the art will recognize that other forms of repositories for collecting and indexing information can be used such as a database.

The recently used artifact information in the data store 14 is presented to a user via a user interface 16. The user interface 16 comprises a filter and sorter component 18 that is configured to automatically filter and sort the recently used artifacts in the index according to the current context in which the user is interacting with the tools available in the computer desktop environment. By filtering and sorting according to the current context, the recently used artifacts can be presented to a user in a way that makes it more useful to the end user without requiring any extra work in finding the information that is most relevant to them.

The filter and sorter component is informed by a context identifier 15 that identifies the user's current context on the computer desktop. This context identifier could use inputs from the plurality of listeners 12 to determine what operation the user is currently engaged in using what application. Or, the context identifier could be informed by information from an activity service, or other information that can help determine what the user is currently doing so that the list can be filtered and sorted in the most useful way to the user.

Without the filter and sorter component 18, the user interface 16 would present a list of the n most recently accessed computer artifacts, where n is a default size that could be user configurable. This could result in the list becoming very lengthy and ungainly for the user.

The filter and sorter component 18 can filter and sort the recently used artifacts according to the current context by detecting the operation(s) on the computer in which the user is currently involved. One example of filtering according to context would be when the user currently has shown an input focus in an email addressing field. In this case it is most likely that the user is looking to insert an email address for a person. Therefore, the filter and sorter component 18 would present an expanded view of only the list of people recently accessed, leaving the other object types collapsed but accessible by means such as opening up a submenu. Another example would be if the user's focus is in the body of the email message, then the user most likely wants to insert a file attachment or a URL. As a result, the filter and sorter component 18 would present those objects expanded, with the other item types collapsed to simplify the user interface.

Besides people and email context, it is possible for the filter and sorter component 18 to perform these functions according to an activities context. In this embodiment, the filter and sorter component 18 would associate each computer object with one or more user activities. The index list presented to the filter and sorter component 18 would then be filtered to show only the artifacts that are related to the same activity that the user is currently working on. For example, if a user's path of focus was on planning a trip and writing a paper, then the filter and sorter component 18 would sense these paths to be active and thus filter and sort the objects in the indexed list that associated with the activity of planning a trip or the activity of writing a paper.

People, emails and activity context are only a few possibilities of contexts in which the filter and sorter component 18 can function. One of ordinary skill in the art will recognize that there are other contexts in which the filter and sorter component 18 can function such as social context. For example, if the user's current focus indicates a social context (e.g., chatting with someone via instant messaging, emailing a group of people), then the filter and sorter component 18 could use that social context to show the items in common with those people. Therefore, when receiving an instant message from someone, the filter and sorter component 18 could show all the recent email messages, file attachments, or events associated with that person.

Instead of automatically sorting and filtering the index items from the data store, it is possible to have the filter and sorter component 18 filter according to preferences configured by a user. A reason for filtering and sorting is that it would permit the user to specify the sorting order for items present in the user interface. For example, a user may always want people to show up at the top of the list. Or, if the user is in a customer care center, then he or she might want trouble tickets to go to the top of the list.

One of ordinary skill in the art will recognize that filtering and sorting by preferences set by a user will provide for a multitude of different opportunities. For example, a user can set preferences that allow him or her to decide what is recent; which types of objects to see; and which people or objects to exclude.

It is possible that the results from automatic filtering and sorting and even through user provided preferences may be imperfect because certain items that the user may be looking for could be filtered out. Therefore, the filter and sorter component would have the capability to provide the user via the user interface 16 with access to the complete list of items that were not presented to the user.

As shown in FIG. 1, the user interface 16 further includes a processing operations component 20 that permits a user to perform one of a plurality of processing operations on the recently used artifacts presented to the user. The plurality of processing operations comprise double clicking on one of the recently used artifacts to execute or open the artifact, dragging and dropping one of the recently used artifacts to a different location within the computer desktop environment, and single clicking on one of the recently used artifacts to ascertain further information.

As mentioned above, dragging and dropping recently used artifacts to a different location is not a function that is currently supported by current recency mechanisms. Perhaps the most important example is being able to copy and paste from Recent Documents by using items in the list as a “drag source” for drag and drop. For example, consider a person who saved a file like a PowerPoint document after finishing working on it. Immediately thereafter, the user moves to an email application to send the document as an attachment to others. To the user, this sequence is part of a seamless activity of creating some content and sharing it with others. Yet, PowerPoint and the email client do not share context, so the email client does not know the file that was just saved in PowerPoint is likely to be the one that the user would like to attach in email. Currently, when a user opens a file chooser in the email client to select an attachment it is likely to be aimed at the folder of the last file attached, rather than the folder that the PowerPoint file was just saved into.

The processing operations component 20 overcomes this problem by making the user interface serve as a drag source since saving the file in PowerPoint will add that file into indexed list. Therefore, when a user moves into the email application, the user would have the option via the user interface of bringing up a list that includes the recently saved file, from which a user could drag and drop it into email as an attachment.

The processing operations component 20 also provides the capability of performing this function without involving dragging. In particular, the processing operations component 20 uses a menu-based equivalent to perform copying and pasting operation afforded by the dragging and dropping. In one embodiment, there could be a hotkey-based option to bring up a menu whose functionality would be to insert items from the user interface 16 and which would allow the user to choose via keystroke navigation among the names of the files and references in the list of items appearing in the interface.

One of ordinary skill in the art will recognize that there are a multitude of opportunities that one could use the dragging and dropping feature provided by the interface system 10. For example, a user could view an URL in a web browser and then switch to email to share it with someone else, or switch to a Word document to include it in the text. Also, a user could read an email message and then switch to a spreadsheet or document processor and quickly refer to the content of the email message to accomplish the work in that application. Another example is that a user could send an email message and include a calendar meeting appointment that was just created with some other people.

Also, the processing operations component 20 also permits a user to use the user interface 16 as a “drop target” to receive items that a user would like to drag to. This functionality allows users to add objects to the user interface without having to interact with them first. In this embodiment, when the user drag objects or object shortcuts to the interface a new shortcut is created. As a result, the new shortcut is positioned appropriately by the current organizing principle for the index or manually by the user. For example, a user could open a folder on his or her hard drive and see a document there that they want to read later. Rather than having to open the document now or interact with it in other some way to get it into the user interface display, the user would simply drag the document to the list in the user interface 16 creating a shortcut automatically.

Another operation provided by the processing operations component 20 that is not supported by current recency mechanisms is single clicking on one of the recently used artifacts to ascertain further information. The type of further information that a user could ascertain depends on the type of artifact or object that the user is selecting. For example, if the item was a file found in a folder then the user could find and open its containing folder or obtain information on objects related to the file. If the interested object was a person, then the user could use the processing operations component 20 to ascertain what other groups of people the person is associated with. If the item is an attachment, then the user could open the email message that delivered the attachment.

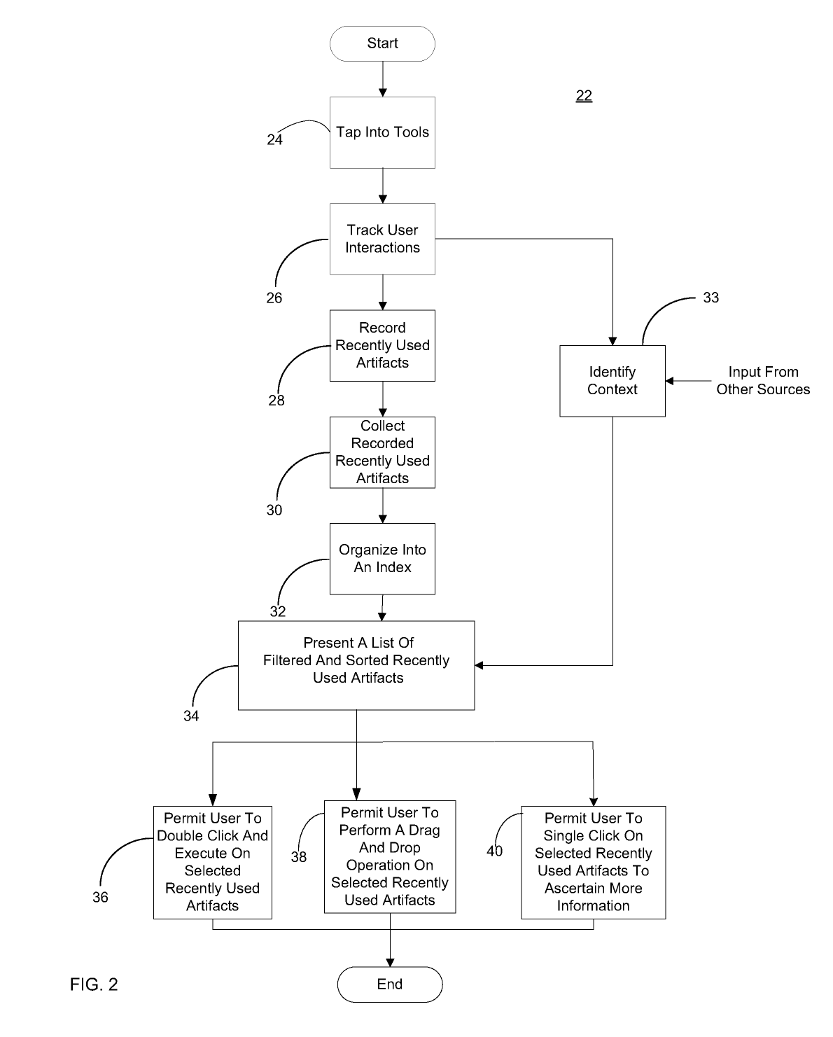

FIG. 2 is a flowchart 22 describing some of the processing functions associated with quickly accessing recently used artifacts in the system shown in FIG. 1. At 24, the plurality of listeners plug into the tools available in the computer desktop environment. The listeners track user's recent interactions with tools at 26 and record recently used artifacts from the tracked user interactions at 28. The data store 14 collects the recorded recently used artifacts from the plurality of listeners at 30 organizes the items into an index at 32. The interface system will present the index items in a list to the user at 34 after performing filtering and sorting. Filtering and sorting is informed by identifying the user's current context at 33, which can use information from tracking the user's interactions and other information sources. The user then has the option of performing one of several processing operations on any of the recently used artifacts. At 36, the user can double click on one of the recently used artifacts in the list to execute or open it. At 38, the user can drag and drop one of the recently used artifacts to a different location within the computer desktop environment. At 40, the user can single click on one of the recently used artifacts to ascertain further information about the artifact.

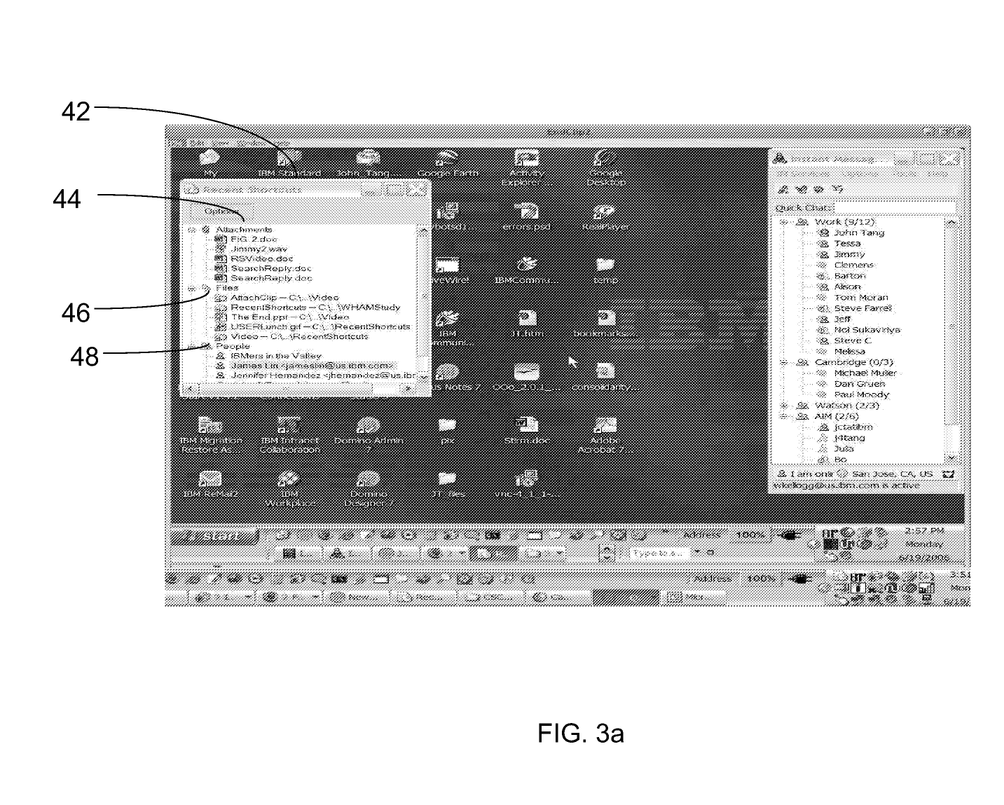

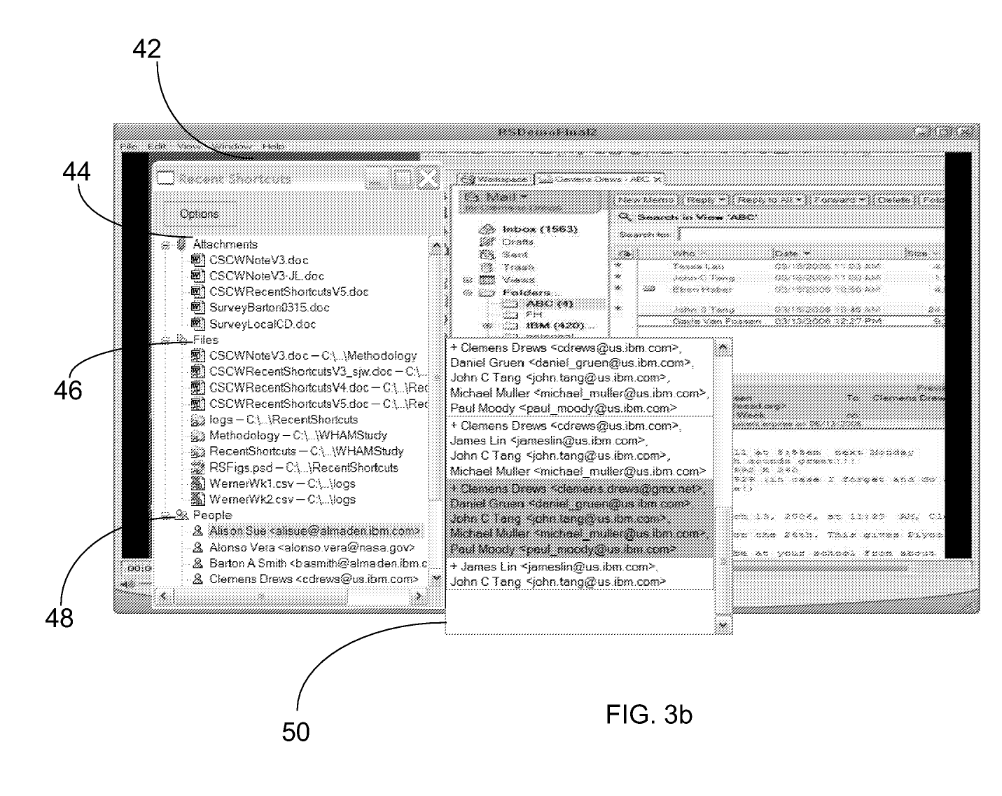

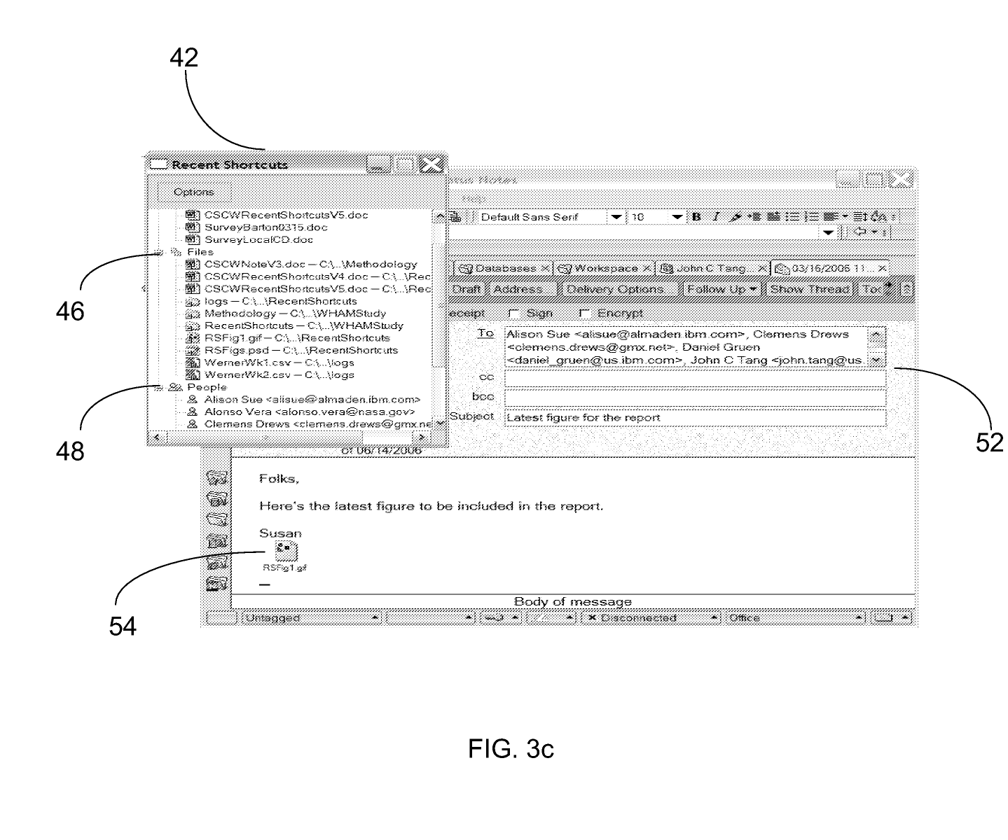

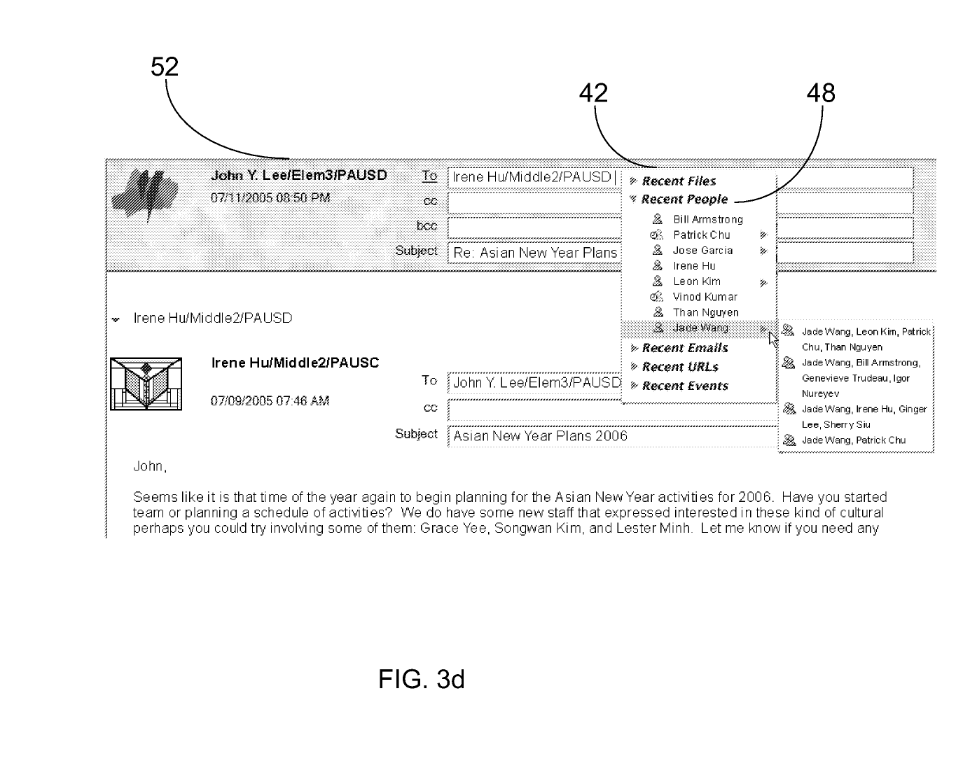

FIGS. 3a-3d show various screen displays that may be presented to a user of the interface system 10 shown in FIG. 1. These screen displays are for illustrative purposes only and are not exhaustive of other types of displays that could be presented to a user. Also, the actual look and feel of the displays can be slightly or substantially changed during implementation. FIG. 3a shows a screen display of a list of indexed recently used artifacts 42 that are presented to a user after he or she activated the interface system. In one embodiment, the interface system can be activated by pressing a pre-programmed hotkey or special function key that works throughout the computer desktop environment. One of ordinary skill in the art will recognize that there are various other ways to invoke the interface system 10. Another approach to invoke the interface system 10 would be to implement it as an entry from the context menu of the application (e.g., the right mouse button menu in Windows). A user could then select the interface system from the context menu which would display the index of recently used artifacts in a submenu. Another option to invoke the interface system 12 would be by including it in an existing system-wide mechanism, like the system tray or start Menu in Windows or the Apple menu in Mac OS, or even a desktop search tool. Another option would be to constantly display the interface, dynamically updating as the user interacts with objects on their computer.

In FIG. 3a, the list of recently used artifacts includes recently reviewed attachments 44 in emails, files and folders 46 recently interacted with, and people 48 recently interacted with via some form of communication application. The attachments 44 show files that have been received as attachments in email messages that the user has recently viewed. To keep the attachments to a minimum a default has been used to show only the last five files attached to email messages that the user has viewed. The user need not have opened the attachment for it to appear in interface 42; the attachments only have to be viewed in the email to which it they were attached. These file attachments can be opened by double-clicking or copied via drag and drop.

The files 46 in the interface 42 as shown in FIG. 3a shows the last 10 (by default) files that the user has interacted with. Also displayed in the screen shot are the folders in the file hierarchy that contain each file, as the folder is often a quick way to get to files related to those that have been recently used. Files and folders can be opened by double-clicking, and files can be copied by drag and drop. In this way, the interface system 10 affords a quick way of accessing a file that was just saved for attachment in an email, for example, making it easier to share information with others.

In FIG. 3a, the people section lists recent people with which the user has interacted via email. The default for how many names of people to list is user selectable. The people in the list includes anyone that appears in the “From”, “To”, and “CC” fields in email messages that have been recently viewed. Selecting any person expands a sub-window that shows the groupings of people that appear together with that person on an email message among the “From”, “To”, and “CC” fields. These “ad hoc” groups of people sometimes represent groups that users want to contact again later on. Double-clicking on a person or group will bring up an email compose window addressed to that person or group. A drag and drop operation will add the email address(es) to applications that recognize that object type. In this way, interface system 10 makes it easier to communicate and share information with others via email.

In one alternative embodiment, it is possible to use visual dividers that represent temporal or other conceptual landmarks between the items in the list (i.e., attachments 44, files and folders 46, and people 48). For example, items accessed earlier in the day might be differentiated from items used in prior days. Or items associated with one activity may be distinguished from items from a different activity.

FIG. 3b shows a screen display of a sub-window 50 that is presented to a user after selecting a name of a person from the people list. In this screen display, the user selected Alison Sue in the main window of the user interface and in the sub-window, a list of names and groups of people that are associated with the selected name are presented to the user. The names and groups of people that are presented are based on “To”, “From” and “CC” fields commonly used in email applications.

FIG. 3c shows a screen display of an email compose window 52 that was addressed by double clicking on a group of people presented in the list of the interface window 42. In addition, in this email compose window 52, the user has dragged and dropped a file 54 from the interface window 42 as an attachment.

FIG. 3d shows a screen display of the result after filtering and sorting according to the context in which the user was interacting with one of the tools available in the computer desktop environment. In FIG. 3d, the user's context or current focus of attention is in the addressing field of an email message as indicated by the email compose window 52. As a result, the filter and sorting component 18 notes this email context and provides only list of recent people that the user interacted with. The people list 48 in the interface 42 is expanded because it believed to be relevant to the user's current focus of attention. All other items in the list, including recent files, emails, URLs and events are collapsed so that only the most likely useful artifacts are available to the user. If the user was not interested in selecting an email address, the user could always expand the other artifact items in the user interface 42 and find whatever information they were interested in.

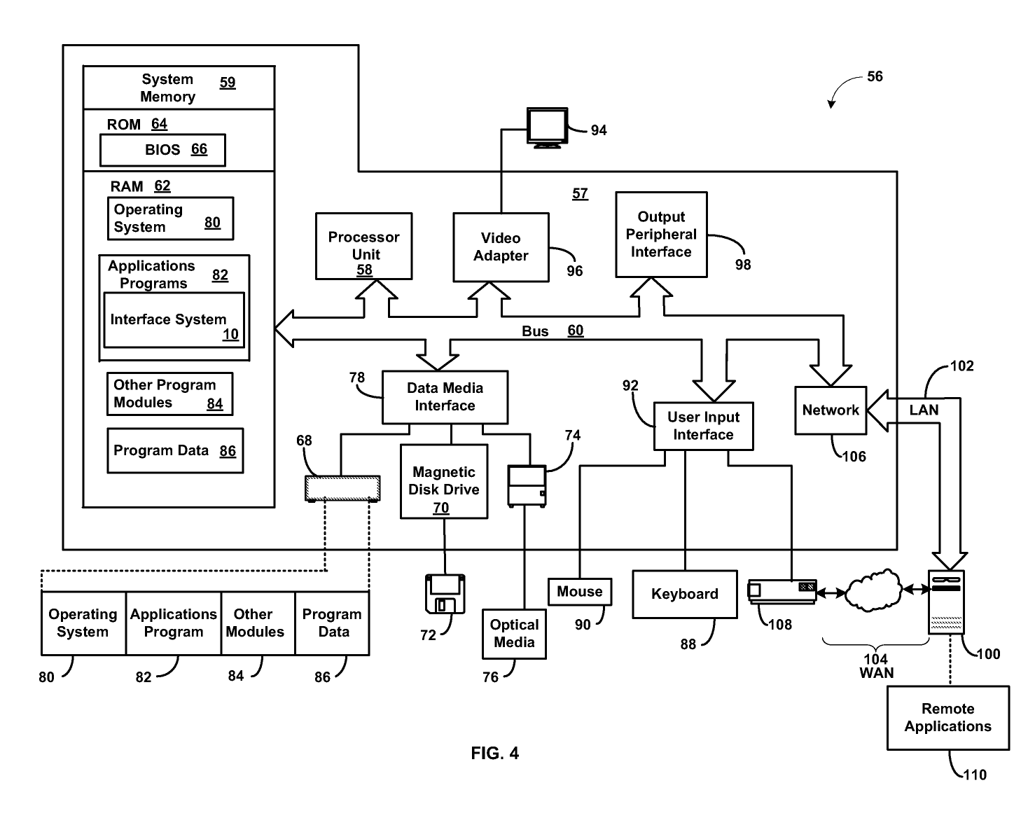

FIG. 4 shows a schematic of an exemplary computing environment 56 in which the interface system shown in FIG. 1 may operate. The exemplary computing environment 56 is only one example of a suitable computing environment and is not intended to suggest any limitation as to the scope of use or functionality of the interface system. Neither should the computing environment 56 be interpreted as having any dependency or requirement relating to any one or combination of components illustrated in FIG. 4.

In the computing environment 56 there is a computer 57 which is operational with numerous other general purpose or special purpose computing system environments or configurations. Examples of well known computing systems, environments, and/or configurations that may be suitable for use with an exemplary computer 57 include, but are not limited to, personal computers, server computers, thin clients, thick clients, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The exemplary computer 57 may be described in the general context of computer-executable instructions, such as program modules, being executed by a computer. Generally, program modules include routines, programs, objects, components, logic, data structures, and so on, that performs particular tasks or implements particular abstract data types. The exemplary computer 57 may be practiced in distributed computing environments where tasks are performed by remote processing devices that are linked through a communications network. In a distributed computing environment, program modules may be located in both local and remote computer storage media including memory storage devices.

As shown in FIG. 4, the computer 57 in the computing environment 56 is shown in the form of a general-purpose computing device. The components of computer 57 may include, but are not limited to, one or more processors or processing units 58, a system memory 59, and a bus 60 that couples various system components including the system memory 59 to the processor 58.

Bus 60 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The computer 57 typically includes a variety of computer readable media. Such media may be any available media that is accessible by computer 57, and it includes both volatile and non-volatile media, removable and non-removable media.

In FIG. 4, the system memory 59 includes computer readable media in the form of volatile memory, such as random access memory (RAM) 62, and/or non-volatile memory, such as read only memory (ROM) 64. A basic input/output system (BIOS) 66 containing the basic routines that help to transfer information between elements within computer 57, such as during start-up, is stored in ROM 64. RAM 62 typically contains data and/or program modules that are immediately accessible to and/or presently operated on by processor 58.

Computer 57 may further include other removable/non-removable, volatile/non-volatile computer storage media. By way of example only, FIG. 4 illustrates a hard disk drive 68 for reading from and writing to a non-removable, non-volatile magnetic media (not shown and typically called a “hard drive”), a magnetic disk drive 70 for reading from and writing to a removable, non-volatile magnetic disk 72 (e.g., a “floppy disk”), and an optical disk drive 74 for reading from or writing to a removable, non-volatile optical disk 76 such as a CD-ROM, DVD-ROM or other optical media. The hard disk drive 68, magnetic disk drive 70, and optical disk drive 74 are each connected to bus 60 by one or more data media interfaces 78.

The drives and their associated computer-readable media provide nonvolatile storage of computer readable instructions, data structures, program modules, and other data for computer 57. Although the exemplary environment described herein employs a hard disk 68, a removable magnetic disk 72 and a removable optical disk 78, it should be appreciated by those skilled in the art that other types of computer readable media which can store data that is accessible by a computer, such as magnetic cassettes, flash memory cards, digital video disks, random access memories (RAMs), read only memories (ROM), and the like, may also be used in the exemplary operating environment.

A number of program modules may be stored on the hard disk 68, magnetic disk 72, optical disk 78, ROM 64, or RAM 62, including, by way of example, and not limitation, an operating system 80, one or more application programs 82 (e.g., interface system 10), other program modules 84, and program data 86.

Each of the operating system 80, one or more application programs 82 other program modules 86, and program data 86 or some combination thereof, may include an implementation of the interface system 10 of FIG. 1. Specifically, each may include an implementation of the interface system 10 which: (a) tracks recent user interactions with tools available in the computer desktop environment; (b) records recently used artifacts from the tracked user interactions; (c) collects the recorded recently used artifacts; (d) provides an index of the collected recently used artifacts; (e) in response to user demand, presents a user interface that displays a list of the recently used artifacts according to the index by using filtering and sorting operations; and, (f) permits a user to perform one of a plurality of processing operations on the recently used artifacts presented to the user, including double clicking, dragging and dropping and single clicking.

A user may enter commands and information into computer 57 through optional input devices such as a keyboard 88 and a pointing device 90 (such as a “mouse”). Other input devices (not shown) may include a microphone, joystick, game pad, satellite dish, serial port, scanner, camera, or the like. These and other input devices are connected to the processing unit 58 through a user input interface 92 that is coupled to bus 60, but may be connected by other interface and bus structures, such as a parallel port, game port, or a universal serial bus (USB).

An optional monitor 94 or other type of display device is also connected to bus 60 via an interface, such as a video adapter 96. In addition to the monitor, personal computers typically include other peripheral output devices (not shown), such as speakers and printers, which may be connected through output peripheral interface 98.

Computer 57 may operate in a networked environment using logical connections to one or more remote computers, such as a remote server/computer 100. Remote computer 100 may include many or all of the elements and features described herein relative to computer 57.

Logical connections shown in FIG. 4 are a local area network (LAN) 102 and a general wide area network (WAN) 104. Such networking environments are commonplace in offices, enterprise-wide computer networks, intranets, and the Internet. When used in a LAN networking environment, the computer 57 is connected to LAN 102 via network interface or adapter 106. When used in a WAN networking environment, the computer typically includes a modem 108 or other means for establishing communications over the WAN 104. The modem, which may be internal or external, may be connected to the system bus 60 via the user input interface 92 or other appropriate mechanism.

In a networked environment, program modules depicted relative to the personal computer 57, or portions thereof, may be stored in a remote memory storage device. By way of example, and not limitation, FIG. 4 illustrates remote application programs 110 as residing on a memory device of remote computer 100. It will be appreciated that the network connections shown and described are exemplary and other means of establishing a communications link between the computers may be used.

An implementation of an exemplary computer 57 may be stored on or transmitted across some form of computer readable media. Computer readable media can be any available media that can be accessed by a computer. By way of example, and not limitation, computer readable media may comprise “computer storage media” and “communications media.”

“Computer storage media” include volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embodies computer readable instructions, data structures, program modules, or other data in a modulated data signal, such as carrier wave or other transport mechanism. Communication media also includes any information delivery media.

The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer readable media.

It is apparent that there has been provided with this disclosure, an interface mechanism for quickly accessing recently used artifacts in a computer desktop environment. While the disclosure has been particularly shown and described in conjunction with a preferred embodiment thereof, it will be appreciated that variations and modifications can be effected by a person of ordinary skill in the art without departing from the scope of the disclosure.

What is claimed is:

1. A method for quickly accessing recently used artifacts in a computer desktop environment, comprising:
tracking recent user interactions with tools available in the computer desktop environment;
recording recently used artifacts from the tracked user interactions;
collecting the recorded recently used artifacts;
providing an index of the collected recently used artifacts;
presenting a user interface that displays a list of the recently used artifacts according to the index; and
permitting a user to perform one of a plurality of processing operations on the recently used artifacts presented to the user, wherein the plurality of processing operations comprise double clicking on one of the recently used artifacts to open or execute, dragging and dropping one of the recently used artifacts to a different location within the computer desktop environment, and single clicking on one of the recently used artifacts to ascertain further information.

2. The method according to claim 1, wherein the presenting of a user interface that displays a list of the recently used artifacts comprises filtering and sorting the artifacts in the index according to the current context in which the user recently interacted with the tools available in the computer desktop environment.

3. The method according to claim 1, wherein the recently used artifacts comprises recently reviewed attachments from incoming email messages, files and folders recently interacted with and people or groups of people recently interacted with.

4. A computer-readable medium storing computer instructions for generating a user interface that allows a user of a computer system to quickly access recently used artifacts within a computer desktop environment, the computer instructions comprising:
tracking recent user interactions with tools available in the computer desktop environment;
recording recently used artifacts from the tracked user interactions;
collecting the recorded recently used artifacts;
providing an index of the collected recently used artifacts;
presenting a user interface that displays a list of the recently used artifacts according to the index, wherein the presenting comprises filtering and sorting the artifacts in the index according to the current context in which the user recently interacted with the tools available in the computer desktop environment; and
permitting a user to perform one of a plurality of processing operations on the recently used artifacts presented to the user, wherein the plurality of processing operations comprise double clicking on one of the recently used artifacts to open or execute, dragging and dropping one of the recently used artifacts to a different location within the computer desktop environment, and single clicking on one of the recently used artifacts to ascertain further information.

5. The computer-readable medium according to claim 4, wherein the recently used artifacts comprises recently reviewed attachments from incoming email messages, files and folders recently interacted with and people or groups of people recently interacted with.

6. A system for quickly accessing recently used artifacts in a computer desktop environment, comprising:
a plurality of listeners configured to track recent user interactions with tools available in the computer desktop environment and record recently used artifacts from the tracked user interactions;
a data store configured to collect the recorded recently used artifacts from the plurality of listeners and organize and index the artifacts; and
a user interface configured to display a list of the recently used artifacts according to the index in the data store, wherein the user interface is further configured to filter and sort the artifacts in the index according to the current context in which the user recently interacted with the tools available in the computer desktop environment, and wherein the user interface is further configured to permit a user to perform one of a plurality of processing operations on the recently used artifacts presented to the user, wherein the plurality of processing operations comprise double clicking on one of the recently used artifacts to open or execute, dragging and dropping one of the recently used artifacts to a different location within the computer desktop environment, and single clicking on one of the recently used artifacts to ascertain further information.
